(19) United States
(12) Patent Application Publication
(10) Pub. No.: US 2024/0416569 A1
(43) Pub. Date: Dec. 19, 2024

(54) CONTROLLER FOR INJECTION MOLDING MACHINE, INJECTION MOLDING MACHINE, AND CONTROL METHOD FOR INJECTION MOLDING MACHINE

(71) Applicant: SUMITOMO HEAVY INDUSTRIES, LTD., Tokyo (JP)

(72) Inventors: Takuya MATSUNAGA, Chiba (JP); Yutaka TSUTSUMI, Chiba (JP)

(21) Appl. No.: 18/659,396

(22) Filed: May 9, 2024

(30) Foreign Application Priority Data
Jun. 14, 2023 (JP) 2023-097825

(51) Int. Cl. B29C 45/78; B29C 45/18; B29C 45/20; B29C 45/66; B29C 45/74

(52) U.S. Cl. CPC B29C 45/78; B29C 45/18; B29C 45/74; B29C 45/20; B29C 45/66; B29C 2945/7604; B29C 2945/7619; B29C 2945/76545; B29C 2945/76668; B29C 2945/76688

(57) ABSTRACT

Provided is a controller for an injection molding machine including an injecting member configured to inject a molding material from a cylinder to a mold part, and a drive source configured to cause the injecting member to operate. The controller includes a cold-start prevention part configured to, when a first condition is met, restrict an operation of the injecting member during a cold-start prevention time that is set in advance. When the first condition is met, the cold-start prevention part determines whether or not a second condition, which is different from the first condition, is met to determine whether or not a value shorter than an initial value will be used as the cold-start prevention time.

### CROSS-REFERENCE TO RELATED APPLICATION

This application is based upon and claims priority to Japanese Patent Application No. 2023-097825, filed on Jun. 14, 2023, the entire contents of which are incorporated herein by reference.

### BACKGROUND

### Technical Field

The present disclosure relates to controllers for injection molding machines, injection molding machines, and control methods for injection molding machines.

### Description of Related Art

An injection molding machine generally includes an injecting member configured to inject a molding material from a cylinder into a mold part, and a drive source configured to cause the injecting member to operate. The injecting member is disposed inside the cylinder. The injecting member is, for example, a screw. The molding material is, for example, resin. The molding material is melted inside the cylinder, and the melted molding material is injected from the cylinder into the mold part. An injection molding machine includes a heater configured to heat a cylinder, and a temperature detector configured to detect an actual temperature of the cylinder.

The injection molding machine controls the heater so that the actual temperature of the cylinder becomes a set temperature. A set temperature of the cylinder is assigned to each operation mode of the injection molding machine.

Operation modes of an injection molding machine include, for example, a molding mode and a temperature-retention mode. In the molding mode, a molding material is injected from a cylinder into a mold part. In the temperature-retention mode, an operation of the injecting member is stopped during the night, holidays, or the like. In the temperature-retention mode, a temperature of the cylinder is set lower than a temperature of the cylinder in the molding mode to inhibit carbonization of a molding material.

Operation modes of an injection molding machine may further include a purge mode. In the purge mode, a molding material is injected from a cylinder into the outside of a mold part, for example, after the temperature-retention mode and before the molding mode, thereby replacing the molding material inside the cylinder. In the purge mode, a temperature of the cylinder is set lower than a temperature of the cylinder in the modeling mode.

A controller of an injection molding machine may cause a cylinder to be heated. Heating of the cylinder is performed, for example, when a set temperature for the molding mode is changed by raising a temperature during the molding mode, when the operation mode of the injection molding machine is switched from the temperature-retention mode or the purge mode to the molding mode, or when an operation is restarted after interruption in electricity supply to a heater due to power cut or operational errors.

If a temperature range for heating a cylinder is large, there may be a time lag between completion of heating of the cylinder and completion of heating of a molding material inside the cylinder. If a drive source causes an injection member to operate before a molding material inside the cylinder is sufficiently heated, an excessive load is applied to the injecting member, which may damage the injecting member. Moreover, molding failure may occur.

Therefore, a controller of an injection molding machine performs control of restricting an operation of the injecting member until a molding material inside a cylinder is sufficiently heated. This control of restricting an operation of the injecting member is referred to as cold-start prevention. Moreover, a duration of the cold-start prevention is referred to as a cold-start prevention time. The cold-start prevention time is set in advance, for example, by experiments or the like, so that a molding material inside a cylinder is sufficiently heated.

If a temperature range for heating a cylinder is small, a molding material inside the cylinder has been already sufficiently heated. In this case, if an operation of the injecting member is restricted during an initially set cold-start prevention time, a standing time until production of molded products is restarted becomes unnecessarily long.

For example, there is a technology where an injection member can be operated based on a type of resin and a suspended time from stopping an operation of a molding machine to restarting an operation of the molding machine, as long as the suspended time is within a predetermined period.

### SUMMARY

According to one aspect of the present disclosure, a controller for an injection molding machine, which includes an injecting member configured to inject a molding material from a cylinder into a mold part, and a drive source configured to cause the injecting member to operate, includes a cold-start prevention part. The cold-start prevention part is configured to, when a first condition is met, restrict an operation of the injecting member during a cold-start prevention time that is set in advance. When the first condition is met, the cold-start prevention part determines whether or not a second condition, which is different from the first condition, is met to determine whether or not a value shorter than an initial value will be used as the cold-start prevention time.

### BRIEF DESCRIPTION OF THE DRAWINGS

FIG. 1 is a diagram illustrating the state of an injection molding machine according to an embodiment at the completion of mold opening;

FIG. 2 is a diagram illustrating the state of the injection molding machine according to the embodiment during mold clamping;

FIG. 3 is a diagram illustrating a functional block of an example of components of a controller;

FIG. 4 is an example of a molding cycle process; and

FIG. 5 is a flowchart illustrating an example of a process performed by a cold-start prevention part.

### DETAILED DESCRIPTION

Control performed according to a type of resin uses a complex calculation program suitable for properties of resin. Moreover, special electrical parts are used to execute the calculation program. Input of information regarding properties of resin is required before operations of an injection molding machine, which demands more tasks to be carried out by a user. Particularly when a type of resin used is frequently changed, the number of tasks carried out by a user increases.

One aspect of the present disclosure provides a technique of simply and appropriately adjusting a cold-start prevention time.

Embodiments of the present disclosure will be described with reference to the drawings. In the drawings, the same or corresponding configurations are referred to using the same or corresponding symbols, and redundant description thereof may be omitted.

### (Injection Molding Machine)

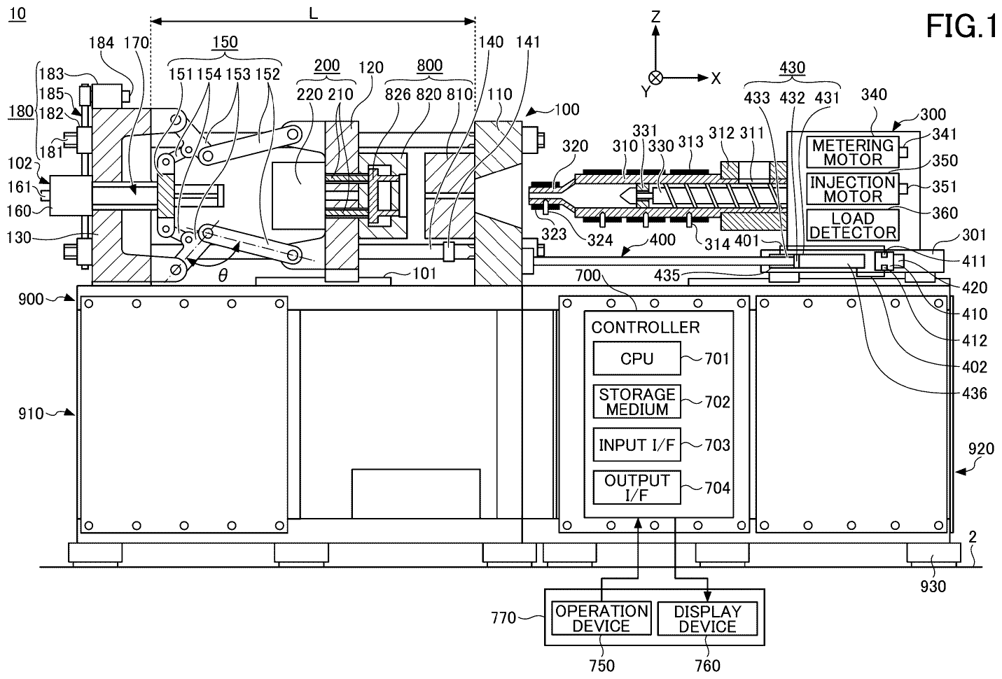

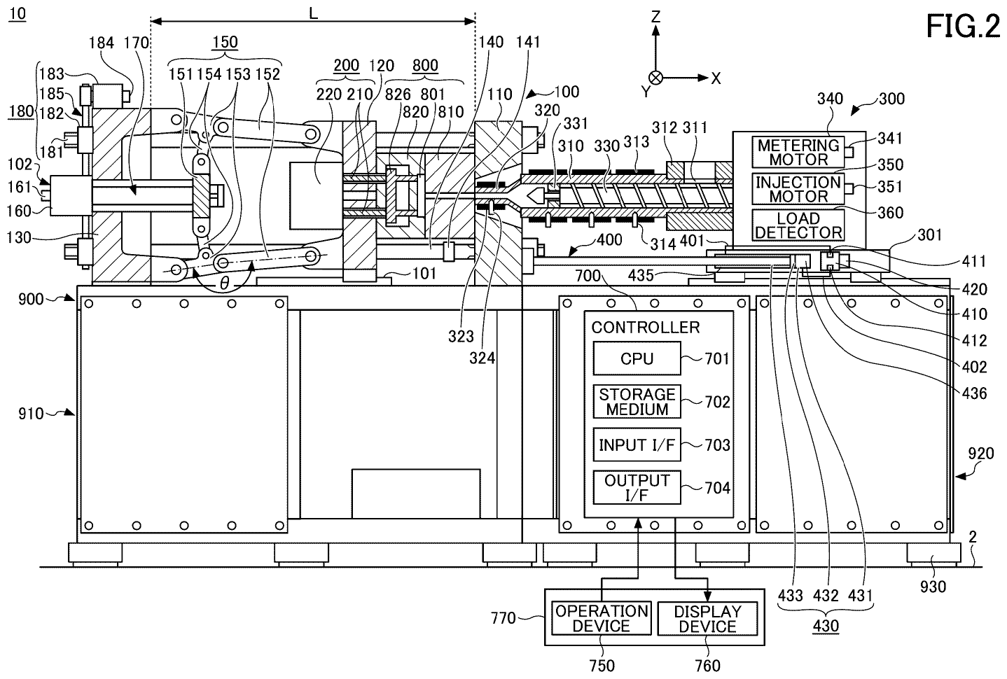

FIG. 1 is a diagram illustrating the state of an injection molding machine according to an embodiment at the completion of mold opening. FIG. 2 is a diagram illustrating the state of the injection molding machine according to this embodiment during mold clamping. In this specification, the X-axis direction, the Y-axis direction, and the Z-axis direction are perpendicular to each other. The X-axis direction and the Y-axis direction represent horizontal directions, and the Z-axis direction represents a vertical direction. When a mold clamping part 100 is of a horizontal type, the X-axis direction is a mold opening/closing direction, and the Y-axis direction is a widthwise direction of an injection molding machine 10. The negative side in the Y-axis direction is referred to as “operation side”, and the positive side in the Y-axis direction is referred to as “non-operation side.”

As illustrated in FIG. 1 and FIG. 2, the injection molding machine 10 includes the mold clamping part 100 that opens and closes a mold part 800, an ejector 200 that ejects a molded product in the mold part 800, an injection part 300 that injects a molding material into the mold part 800, a movement part 400 that moves the injection part 300 toward and away from the mold part 800, a controller 700 that controls the components of the injection molding machine 10, and a frame 900 that supports the components of the injection molding machine 10. The frame 900 includes a mold clamping part frame 910 that supports the mold clamping part 100 and an injection part frame 920 that supports the injection part 300. Each of the mold clamping part frame 910 and the injection part frame 920 is installed on a floor 2 via at least one leveling adjuster 930. The controller 700 is placed in the internal space of the injection part frame 920. Each component of the injection molding machine 10 is described below.

### (Mold Clamping Part)

In the description of the mold clamping part 100, the direction of movement of a movable platen 120 during mold closing (e.g., the positive X-axis direction) is referred to as “forward direction”, and the direction of movement of the movable platen 120 during mold opening (e.g., the negative X-axis direction) is referred to as “backward direction.”

The mold clamping part 100 closes, pressurizes, clamps, depressurizes, and opens the mold part 800. The mold part 800 includes a stationary mold 810 and a movable mold 820.

The mold clamping part 100 is, for example, of a horizontal type, and the mold opening and closing directions are horizontal directions. The mold clamping part 100 includes a stationary platen 110 to which the stationary mold 810 is attached, the movable platen 120 to which the movable mold 820 is attached, and a movement mechanism 102 that moves the movable platen 120 in the mold opening and closing directions relative to the stationary platen 110.

The stationary platen 110 is fixed to the mold clamping part frame 910. The stationary mold 810 is attached to a surface of the stationary platen 110 that faces the movable platen 120.

The movable platen 120 is placed to be movable in the mold opening and closing directions relative to the mold clamping part frame 910. A guide 101 that guides the movable platen 120 is laid on the mold clamping part frame 910. The movable mold 820 is attached to a surface of the movable platen 120 that faces the stationary platen 110.

The movement mechanism 102 moves the movable platen 120 toward and away from the stationary platen 110 to close, pressurize, clamp, depressurize, and open the mold part 800. The movement mechanism 102 includes a toggle support 130 spaced apart from the stationary platen 110, a tie bar 140 connecting the stationary platen 110 and the toggle support 130, a toggle mechanism 150 that moves the movable platen 120 in the mold opening and closing directions relative to the toggle support 130, a mold clamping motor 160 that actuates the toggle mechanism 150, a motion conversion mechanism 170 that converts the rotational motion of the mold clamping motor 160 into linear motion, and a mold thickness adjustment mechanism 180 that adjusts the interval between the stationary platen 110 and the toggle support 130.

The toggle support 130 is spaced apart from the stationary platen 110 and is placed on the mold clamping part frame 910 to be movable in the mold opening and closing directions. The toggle support 130 may be placed to be movable along a guide laid on the mold clamping part frame 910. The guide 101 of the movable platen 120 may also serve as the guide of the toggle support 130.

According to this embodiment, the stationary platen 110 is fixed to the mold clamping part frame 910 and the toggle support 130 is placed to be movable in the mold opening and closing directions relative to the mold clamping part frame 910. However, the toggle support 130 may be fixed to the mold clamping part frame 910 and the stationary platen 110 may be placed to be movable in the mold opening and closing directions relative to the mold clamping part frame 910.

The tie bar 140 connects the stationary platen 110 and the toggle support 130 with an interval (distance) L therebetween in the mold opening and closing directions. Multiple (e.g., four) tie bars may be used as the tie bar 140. The multiple tie bars 140 are placed parallel to the mold opening and closing directions and extend according to a mold clamping force. At least one tie bar 140 among the multiple tie bars 140 may be provided with a tie bar strain detector 141 that detects the strain of the tie bar 140. The tie bar strain detector 141 transmits a signal indicating the detection result to the controller 700. The detection result of the tie bar strain detector 141 is used to detect the mold clamping force.

According to this embodiment, the tie bar strain detector 141 is used as a mold clamping force detector to detect a mold clamping force. The present disclosure, however, is not limited to this configuration. The mold clamping force detector is not limited to be of a strain gauge type and may be of a piezoelectric type, a capacitive type, a hydraulic type, an electromagnetic type, or the like, and its attachment position is not limited to the tie bar 140.

The toggle mechanism 150 is placed between the movable platen 120 and the toggle support 130, and moves the movable platen 120 in the mold opening and closing directions relative to the toggle support 130. The toggle mechanism 150 includes a crosshead 151 that moves in the mold opening and closing directions and a pair of link groups that are extended and contracted by the movement of the crosshead 151. Each link group includes a first link 152 and a second link 153 that are extendable and contractible when connected by a pin or the like. The first link 152 is pivotably attached to the movable platen 120 with a pin or the like. The second link 153 is pivotably attached to the toggle support 130 with a pin or the like. The second link 153 is attached to the crosshead 151 via a third link 154. The crosshead 151 is moved toward or away from the toggle support 130 to contract or extend the first link 152 and the second link 153 to move the movable platen 120 toward or away from the toggle support 130.

The configuration of the toggle mechanism 150 is not limited to the configuration illustrated in FIG. 1 and FIG. 2. For example, the number of nodes of each link group, which is five in FIG. 1 and FIG. 2, may be four, and one end of the third link 154 may be connected to the node of the first link 152 and the second link 153.

The mold clamping motor 160 is attached to the toggle support 130 to actuate the toggle mechanism 150. The mold clamping motor 160 moves the crosshead 151 toward or away from the toggle support 130 to contract or extend the first link 152 and the second link 153 to move the movable platen 120 toward or away from the toggle support 130. The mold clamping motor 160, which is directly connected to the motion conversion mechanism 170, may alternatively be connected to the motion conversion mechanism 170 via a belt or pulley.

The motion conversion mechanism 170 converts the rotational motion of the mold clamping motor 160 into the linear motion of the crosshead 151. The motion conversion mechanism 170 includes a screw shaft and a screw nut screwed to the screw shaft. Balls or rollers may be interposed between the screw shaft and the screw nut.

The mold clamping part 100 performs a mold closing process, a pressurizing process, a mold clamping process, a depressurizing process, a mold opening process, and the like under the control of the controller 700.

In the mold closing process, the mold clamping motor 160 is driven to move the crosshead 151 forward to a mold closing completion position at a set travel speed to move the movable platen 120 forward to cause the movable mold 820 to touch the stationary mold 810. The position and travel speed of the crosshead 151 are detected using a mold clamping motor encoder 161 or the like. The mold clamping motor encoder 161 detects the rotation of the mold clamping motor 160 and transmits a signal indicating the detection results to the controller 700.

A crosshead position detector that detects the position of the crosshead 151 and a crosshead travel speed detector that detects the travel speed of the crosshead 151 are not limited to the mold clamping motor encoder 161 and common ones may be employed. Furthermore, a movable platen position detector that detects the position of the movable platen 120 and a movable platen travel speed detector that detects the travel speed of the movable platen 120 are not limited to the mold clamping motor encoder 161 and common ones may be employed.

In the pressurizing process, the mold clamping motor 160 is further driven to further move the crosshead 151 from the mold closing completion position to a mold clamping position, thereby generating a mold clamping force.

In the mold clamping process, the mold clamping motor 160 is driven to maintain the position of the crosshead 151 at the mold clamping position. In the mold clamping process, the mold clamping force generated in the pressurizing process is maintained. In the mold clamping process, a cavity space 801 (see FIG. 2) is formed between the movable mold 820 and the stationary mold 810, and the injection part 300 fills the cavity space 801 with a liquid molding material. The molding material is solidified, so that a molded product is obtained.

The number of cavity spaces 801 may be one or more. In the latter case, multiple molded products are simultaneously obtained. An insert material may be placed in part of the cavity space 801 and the molding material may fill another part of the cavity space 801. Thereby, a molded product into which the insert material and the molding material are integrated is obtained.

In the depressurizing process, the mold clamping motor 160 is driven to move the crosshead 151 backward from the mold clamping position to a mold opening start position to move the movable platen 120 backward to reduce the mold clamping force. The mold opening start position and the mold closing completion position may be the same position.

In the mold opening process, the mold clamping motor 160 is driven to move the crosshead 151 backward from the mold opening start position to a mold opening completion position at a set travel speed to move the movable platen 120 backward to separate the movable mold 820 from the stationary mold 810. Thereafter, the ejector 200 ejects the molded product from the movable mold 820.

Set conditions in the mold closing process, the pressurizing process, and the mold clamping process are collectively set as a series of set conditions. For example, the travel speed and positions (including a mold closing start position, a travel speed switch position, the mold closing completion position, and the mold clamping position) of the crosshead 151 and the mold clamping force in the mold closing process and the pressurizing process are collectively set as a series of set conditions. The mold closing start position, the travel speed switch position, the mold closing completion position, and the mold clamping position, which are arranged in this order in the forward direction from the back side, represent the start points and end points of sections for which the travel speed is set. The travel speed is set section by section. There may be one or more travel speed switch positions. The travel speed switch position may not be set. Only one of the mold clamping position and the mold clamping force may be set.

Setting conditions in the depressurizing process and the mold opening process are likewise set. For example, the travel speed and positions (the mold opening start position, the travel speed switch position, and the mold opening completion position) of the crosshead 151 in the depressurizing process and the mold opening process are collectively set as a series of set conditions. The mold opening start position, the travel speed switch position, and the mold opening completion position, which are arranged in this order in the backward direction from the front side, represent the start points and end points of sections for which the travel speed is set. The travel speed is set section by section. There may be one or more travel speed switch positions. The travel speed switch position may not be set. The mold opening start position and the mold closing completion position may be the same position. The mold opening completion position and the mold closing start position may be the same position.

Instead of the travel speed, position, and the like, of the crosshead 151, the travel speed, position, and the like, of the movable platen 120 may be set. Furthermore, instead of the crosshead position (e.g., the mold clamping position) or the movable platen position, the mold clamping force may be set.

The toggle mechanism 150 amplifies the driving force of the mold clamping motor 160 and transmits the amplified driving force to the movable platen 120. The amplification factor is also referred to as “toggle multiplying factor.” The toggle multiplying factor changes according to the angle θ formed by the first link 152 and the second link 153 (hereinafter also referred to as “link angle 0”). The link angle θ is determined from the position of the crosshead 151. The toggle multiplying factor is maximized when the link angle θ is 180°.

When there is a change in the thickness of the mold part 800 because of the replacement of the mold part 800 or a change in the temperature of the mold part 800, the mold thickness is adjusted to obtain a predetermined mold clamping force at the time of mold clamping. In adjusting the mold thickness, for example, the interval L between the stationary platen 110 and the toggle support 130 is adjusted so that the link angle θ of the toggle mechanism 150 becomes a predetermined angle at the time of mold touch when the movable mold 820 touches the stationary mold 810.

The mold clamping part 100 includes the mold thickness adjustment mechanism 180. The mold thickness adjustment mechanism 180 adjusts the mold thickness by adjusting the interval L between the stationary platen 110 and the toggle support 130. The mold thickness is adjusted between the end of a molding cycle and the start of the next molding cycle, for example. The mold thickness adjustment mechanism 180 includes, for example, a threaded shaft 181 formed at the rear end of each tie bar 140, a threaded nut 182 held on the toggle support 130 in such a manner as to be rotatable and impossible to move forward or backward, and a mold thickness adjustment motor 183 that rotates the threaded nut 182 mating with the threaded shaft 181.

The threaded shaft 181 and the threaded nut 182 are provided for each tie bar 140. The rotational driving force of the mold thickness adjustment motor 183 may be transmitted to the multiple threaded nuts 182 via a rotational driving force transmission part 185. It is possible to synchronously rotate the multiple threaded nuts 182. The multiple threaded nuts 182 may be individually rotated by changing the transmission channel of the rotational driving force transmission part 185.

The rotational driving force transmission part 185 is constituted of, for example, gears. In such a case, a driven gear is formed at the periphery of each threaded nut 182, a drive gear is attached to the output shaft of the mold thickness adjustment motor 183, and an intermediate gear that meshes with the driven gears and the drive gear is rotatably held in the center of the toggle support 130. The rotational driving force transmission part 185 may be constituted of a belt and pulleys instead of gears.

The operation of the mold thickness adjustment mechanism 180 is controlled by the controller 700. The controller 700 drives the mold thickness adjustment motor 183 to rotate the threaded nuts 182. As a result, the position of the toggle support 130 relative to the tie bars 140 is adjusted, and the interval L between the stationary platen 110 and the toggle support 130 is adjusted. Multiple mold thickness adjustment mechanisms may be used in combination.

The interval L is detected using a mold thickness adjustment motor encoder 184. The mold thickness adjustment motor encoder 184 detects the amount of rotation and the direction of rotation of the mold thickness adjustment motor 183, and transmits a signal indicating the detection results to the controller 700. The detection results of the mold thickness adjustment motor encoder 184 are used to monitor and control the position of the toggle support 130 and the interval L. A toggle support position detector that detects the position of the toggle support 130 and an interval detector that detects the interval L are not limited to the mold thickness adjustment motor encoder 184 and common ones may be employed.

The mold clamping part 100 may include a mold temperature adjuster that adjusts the temperature of the mold part 800. The mold part 800 contains a flow channel for a temperature adjust medium. The mold temperature adjuster adjusts the temperature of the mold part 800 by adjusting the temperature of the temperature adjust medium supplied to the flow channel of the mold part 800.

The mold clamping part 100, which is of a horizontal type whose mold opening and closing directions are horizontal directions according to this embodiment, may also be of a vertical type whose mold opening and closing directions are vertical directions.

The mold clamping part 100, which includes the mold clamping motor 160 as a drive source according to this embodiment, may also include a hydraulic cylinder instead of the mold clamping motor 160. Furthermore, the mold clamping part 100 may include a linear motor for mold opening and closing and may include an electromagnet for mold clamping.

### (Ejector)

In the description of the ejector 200, similar to the description of the mold clamping part 100, the direction of movement of the movable platen 120 during mold closing (e.g., the positive X-axis direction) is referred to as “forward direction”, and the direction of movement of the movable platen 120 during mold opening (e.g., the negative X-axis direction) is referred to as “backward direction.”

The ejector 200 is attached to the movable platen 120 and moves forward and backward together with the movable platen 120. The ejector 200 includes one or more ejector rods 210 that eject a molded product from the mold part 800 and a drive mechanism 220 that moves the ejector rod 210 in the directions of movement (the X-axis direction) of the movable platen 120.

Each ejector rod 210 is placed in a through hole of the movable platen 120 to be movable forward and backward. The front end of the ejector rod 210 contacts an ejector plate 826 of the movable mold 820. The front end of the ejector rod 210 may be connected to or disconnected from the ejector plate 826.

The drive mechanism 220 includes, for example, an ejector motor and a motion conversion mechanism that converts the rotational motion of the ejector motor into the linear motion of the ejector rod 210. The motion conversion mechanism includes a threaded shaft and a threaded nut that mates with the threaded shaft. Balls or rollers may be interposed between the threaded shaft and the threaded nut.

The ejector 200 executes an ejection process under the control of the controller 700. In the ejection process, the ejector rods 210 are moved forward from a standby position to an ejection position at a set travel speed to move the ejector plate 826 forward to eject a molded product. Thereafter, the ejector motor is driven to move the ejector rods 210 backward at a set travel speed to move the ejector plate 826 backward to the initial standby position.

The position and travel speed of the ejector rods 210 are detected using an ejector motor encoder, for example. The ejector motor encoder detects the rotation of the ejector motor to transmit a signal indicating the detection results to the controller 700. An ejector rod position detector that detects the position of the ejector rods 210 and an ejector rod travel speed detector that detects the travel speed of the ejector rods 210 are not limited to the ejector motor encoder and common ones may be employed.

### (Injection Part)

Unlike in the description of the mold clamping part 100 and the ejector 200, in the description of the injection part 300, the direction of movement of a screw 330 during filling (e.g., the negative X-axis direction) is referred to as “forward direction”, and the direction of movement of the screw 330 during metering (e.g., the positive X-axis direction) is referred to as “backward direction.”

The injection part 300 is installed on a slidable base 301, and the slidable base 301 is so placed as to be movable forward and backward relative to the injection part frame 920. The injection part 300 is so placed as to be movable toward and away from the mold part 800. The injection part 300 touches the mold part 800 to fill the cavity space 801 within the mold part 800 with a molding material. The injection part 300 includes, for example, a cylinder 310 that heats a molding material, a nozzle 320 provided at the front end of the cylinder 310, the screw 330 so placed in the cylinder 310 as to be movable forward and backward and rotatable, a metering motor 340 that rotates the screw 330, an injection motor 350 that moves the screw 330 forward and backward, and a load detector 360 that detects a load transmitted between the injection motor 350 and the screw 330.

The cylinder 310 heats a molding material supplied to the inside through a supply port 311. Examples of the molding material include resin. The molding material is formed into pellets, for example, and is supplied to the supply port 311 in a solid state. The supply port 311 is formed in a rear portion of the cylinder 310. A cooler 312 such as a water-cooled cylinder is provided on the outer cylindrical surface of the rear portion of the cylinder 310. First heaters 313 such as a band heater and first temperature detectors 314 are provided forward of the cooler 312 on the outer cylindrical surface of the cylinder 310.

The cylinder 310 is divided into multiple zones in the axial direction (e.g., the X-axis direction) of the cylinder 310. Each zone is provided with the first heater 313 and the first temperature detector 314. A temperature is set for each zone and the controller 700 controls the first heater 313 so that the temperature detected by the first temperature detector 314 becomes the set temperature.

The nozzle 320 is provided at the front end of the cylinder 310 to be pressed against the mold part 800. A second heater 323 and a second temperature detector 324 are provided at the periphery of the nozzle 320. The controller 700 controls the second heater 323 so that the detected temperature of the nozzle 320 becomes the set temperature.

The screw 330 is placed in the cylinder 310 to be rotatable and movable forward and backward. When the screw 330 rotates, a molding material is fed forward along the helical groove of the screw 330. The molding material is gradually melted by heat from the cylinder 310 as the molding material is fed forward. As the molding material in liquid form is fed forward on the screw 330 to be accumulated in the front of the cylinder 310, the screw 330 is moved backward. Thereafter, when the screw 330 is moved forward, the molding material in liquid form accumulated in front of the screw 330 is injected into the mold part 800 through the nozzle 320.

A backflow prevention ring 331 is so attached to a front portion of the screw 330 as to be movable forward and backward as a backflow check valve that prevents the backflow of the molding material from the front to the back of the screw 330 when the screw 330 is pushed forward.

When the screw 330 is moved forward, the backflow prevention ring 331 is pushed backward by the pressure of the molding material in front of the screw 330 to move backward relative to the screw 330 to a closing position (see FIG. 2) that closes the flow channel of the molding material, thereby preventing the backflow of the molding material accumulated in front of the screw 330 in the backward direction.

When the screw 330 is rotated, the backflow prevention ring 331 is pushed forward by the pressure of the molding material fed forward along the helical groove of the screw 330 to move forward relative to the screw 330 to an open position (see FIG. 1) that opens the flow channel of the molding material. As a result, the molding material is fed forward of the screw 330.

The backflow prevention ring 331 may be of a co-rotating type that rotates together with the screw 330 or of a non-co-rotating type that does not rotate together with the screw 330.

The injection part 300 may include a drive source that moves the backflow prevention ring 331 forward and backward between the open position and the closing position relative to the screw 330.

The metering motor 340 rotates the screw 330. The drive source that rotates the screw 330 is not limited to the metering motor 340 and may be, for example, a hydraulic pump.

The injection motor 350 moves the screw 330 forward and backward. A motion conversion mechanism that converts the rotational motion of the injection motor 350 into the linear motion of the screw 330, and the like, are provided between the injection motor 350 and the screw 330. The motion conversion mechanism includes, for example, a threaded shaft and a threaded nut that mates with the threaded shaft. Balls or rollers may be provided between the threaded shaft and the threaded nut. The drive source that moves the screw 330 forward and backward is not limited to the injection motor 350, and may be, for example, a hydraulic cylinder.

The load detector 360 detects a load transmitted between the injection motor 350 and the screw 330. The detected load is converted into pressure in the controller 700. The load detector 360 is provided in the load transmission path between the injection motor 350 and the screw 330 to detect a load applied to the load detector 360.

The load detector 360 transmits a signal of the detected load to the controller 700. The load detected by the load detector 360 is converted into a pressure applied between the screw 330 and the molding material, and is used to control and monitor a pressure that the screw 330 receives from the molding material, a back pressure against the screw 330, a pressure applied from the screw 330 to the molding material, and the like.

A pressure detector that detects the pressure of a molding material is not limited to the load detector 360 and a common one may be employed. For example, a nozzle pressure sensor or a cavity pressure sensor may be employed. The nozzle pressure sensor is placed in the nozzle 320. The cavity pressure sensor is placed within the mold part 800.

The injection part 300 executes processes such as a metering process, a filling process, and a dwelling process under the control of the controller 700. The filling process and the dwelling process may be collectively referred to as “injection process.”

In the metering process, the metering motor 340 is driven to rotate the screw 330 at a set rotational speed to feed a molding material forward along the helical groove of the screw 330. With this, the molding material is gradually melted. As the molding material in liquid form is fed forward of the screw 330 to be accumulated in the front portion of the cylinder 310, the screw 330 is moved backward. The rotational speed of the screw 330 is detected using a metering motor encoder 341 or the like. The metering motor encoder 341 detects the rotation of the metering motor 340 and transmits a signal indicating the detection results to the controller 700. A screw rotational speed detector that detects the rotational speed of the screw 330 is not limited to the metering motor encoder 341 and a common one may be employed.

In the metering process, in order to restrict a sudden backward movement of the screw 330, the injection motor 350 may be driven to apply a set back pressure to the screw 330. The back pressure to the screw 330 is detected using the load detector 360, for example. When the screw 330 is moved backward to a metering completion position and a predetermined amount of molding material is accumulated in front of the screw 330, the metering process is completed.

The position and rotational speed of the screw 330 in the metering process are collectively set as a series of set conditions. For example, a metering start position, a rotational speed switch position, and the metering completion position are set. These positions, which are arranged in this order in the backward direction from the front side, represent the start points and end points of sections for which the rotational speed is set. The rotational speed is set section by section. There may be one or more rotational speed switch positions. The rotational speed switch position may not be set. Furthermore, a back pressure is set for each section.

In the filling process, the injection motor 350 is driven to move the screw 330 forward at a set travel speed to fill the cavity space 801 within the mold part 800 with the molding material in liquid form accumulated in front of the screw 330. The position and travel speed of the screw 330 are detected using an injection motor encoder 351, for example. The injection motor encoder 351 detects the rotation of the injection motor 350 and transmits a signal indicating the detection results to the controller 700. When the position of the screw 330 reaches a set position, the filling process switches to the dwelling process (so-called V/P switchover). The position at which V/P switchover occurs may be referred to as “V/P switchover position.” The set travel speed of the screw 330 may be changed according to the position of the screw 330, time, and the like.

The position and travel speed of the screw 330 in the filling process are collectively set as a series of set conditions. For example, a filling start position (also referred to as “injection start position”), a travel speed switch position, and the V/P switchover position are set. These positions, which are arranged in this order in the forward direction from the back side, represent the start points and end points of sections for which the travel speed is set. The travel speed is set section by section. There may be one or more travel speed switch positions.

The travel speed switch position may not be set. The upper limit of the pressure of the screw 330 is set for each section for which the travel speed of the screw 330 is set. The pressure of the screw 330 is detected by the load detector 360. When the pressure of the screw 330 is less than or equal to a set pressure, the screw 330 is moved forward at a set travel speed. When the pressure of the screw 330 exceeds the set pressure, the screw 330 is moved forward at a travel speed lower than the set travel speed so that the pressure of the screw 330 is less than or equal to the set pressure, for mold protection.

In the filling process, after the position of the screw 330 reaches the V/P switchover position, the screw 330 may be temporarily stopped at the V/P switchover position and the V/P switchover may be thereafter performed. Immediately before the V/P switchover, the screw 330 may be moved forward or backward very slowly instead of being stopped. A screw position detector that detects the position of the screw 330 and a screw travel speed detector that detects the travel speed of the screw 330 are not limited to the injection motor encoder 351 and common ones may be employed.

In the dwelling process, the injection motor 350 is driven to push the screw 330 forward to hold the pressure of the molding material at the front end of the screw 330 (hereinafter also referred to as “dwell pressure”) at a set pressure and press the molding material remaining in the cylinder 310 toward the mold part 800. It is possible to compensate for a shortage of molding material due to cooling contraction within the mold part 800. The dwell pressure is detected using the load detector 360, for example. The set value of the dwell pressure may be changed according to elapsed time from the start of the dwelling process or the like. Two or more values may be set for each of the dwell pressure and the dwell time for holding the dwell pressure in the dwelling process, and the dwell pressure and the dwell time may be collectively set as a series of set conditions.

In the dwelling process, the molding material in the cavity space 801 within the mold part 800 is gradually cooled, so that the entrance of the cavity space 801 is filled up with the solidified molding material when the dwelling process is completed. This state, which is referred to as “gate seal,” prevents the backflow of the molding material from the cavity space 801. After the dwelling process, a cooling process is started. In the cooling process, the molding material in the cavity space 801 is solidified. The metering process may be executed during the cooling process in order to reduce molding cycle time.

The injection part 300, which is of an in-line screw type according to this embodiment, may be of a screw pre-plasticizing type. According to the screw pre-plasticizing injection part, a molding material melted in a plasticizing cylinder is supplied to an injection cylinder, and the molding material is injected into a mold part from the injection cylinder. In the plasticizing cylinder, a screw is so placed as to be rotatable and immovable forward or backward or a screw is so placed as to be rotatable and movable forward and backward. In the injection cylinder, a plunger is so placed as to be movable forward and backward.

Furthermore, the injection part 300, which is of a horizontal type where the axial direction of the cylinder 310 is a horizontal direction according to this embodiment, may be of a vertical type where the axial direction of the cylinder 310 is a vertical direction. A mold clamping part combined with the injection part 300 of a vertical type may be of a horizontal type or a vertical type. Likewise, a mold clamping part combined with the injection part 300 of a horizontal type may be of a horizontal type or a vertical type.

### (Movement Part)

In the description of the movement part 400, similar to the description of the injection part 300, the direction of movement of the screw 330 during filling (e.g., the negative X-axis direction) is referred to as “forward direction”, and the direction of movement of the screw 330 during metering (e.g., the positive X-axis direction) is referred to as “backward direction.”

The movement part 400 moves the injection part 300 toward and away from the mold part 800. Furthermore, the movement part 400 presses the nozzle 320 against the mold part 800 to generate a nozzle touch pressure. The movement part 400 includes a hydraulic pump 410, a motor 420 serving as a drive source, and a hydraulic cylinder 430 serving as a hydraulic actuator.

The hydraulic pump 410 includes a first port 411 and a second port 412. The hydraulic pump 410, which is a bidirectionally rotatable pump, switches the rotational direction of the motor 420 to take in hydraulic fluid (e.g., oil) from one of the first port 411 and the second port 412 and discharge hydraulic fluid from the other of the first port 411 and the second port 412, thereby generating hydraulic pressure. The hydraulic pump 410 may take in hydraulic fluid from a tank and discharge hydraulic fluid from one of the first port 411 and the second port 412.

The motor 420 causes the hydraulic pump 410 to operate. The motor 420 drives the hydraulic pump 410 with a rotational direction and a rotation torque corresponding to a control signal from the controller 700. The motor 420 may be an electric motor and may be an electric servo motor.

The hydraulic cylinder 430 includes a cylinder body 431, a piston 432, and a piston rod 433. The cylinder body 431 is fixed to the injection part 300. The piston 432 separates the inside of the cylinder body 431 into a front chamber 435 serving as a first chamber and a rear chamber 436 serving as a second chamber. The piston rod 433 is fixed to the stationary platen 110.

The front chamber 435 of the hydraulic cylinder 430 is connected to the first port 411 of the hydraulic pump 410 via a first flow channel 401. Hydraulic fluid discharged from the first port 411 is supplied to the front chamber 435 via the first flow channel 401 to push the injection part 300 forward. The injection part 300 is moved forward to press the nozzle 320 against the stationary mold 810. The front chamber 435 serves as a pressure chamber that generates the nozzle touch pressure of the nozzle 320 with the pressure of the hydraulic fluid supplied from the hydraulic pump 410.

The rear chamber 436 of the hydraulic cylinder 430 is connected to the second port 412 of the hydraulic pump 410 via a second flow channel 402. Hydraulic fluid discharged from the second port 412 is supplied to the rear chamber 436 of the hydraulic cylinder 430 via the second flow channel 402 to push the injection part 300 backward. The injection part 300 is moved backward to separate the nozzle 320 from the stationary mold 810.

According to this embodiment, the movement part 400 includes the hydraulic cylinder 430. The present disclosure, however, is not limited to this. For example, instead of the hydraulic cylinder 430, an electric motor and a motion conversion mechanism that converts the rotational motion of the electric motor into the linear motion of the injection part 300 may be employed.

### (Controller)

The controller 700, which is composed of, for example, a computer, includes a central processing unit (CPU) 701, a storage medium 702 such as a memory, an input interface (I/F) 703, and an output interface (I/F) 704 as illustrated in FIG. 1 and FIG. 2. The controller 700 executes various controls by causing the CPU 701 to execute one or more programs stored in the storage medium 702. Furthermore, the controller 700 receives an external signal at the input interface 703 and transmits a signal to the outside at the output interface 704.

The controller 700 repeatedly produces a molded product by repeatedly executing processes such as the metering process, the mold closing process, the pressurizing process, the mold clamping process, the filling process, the dwelling process, the cooling process, the depressurizing process, the mold opening process, and the ejection process. A series of operations for obtaining a molded product, for example, operations from the start of a metering process and the start of the next metering process, may be referred to as “shot” or “molding cycle.” Furthermore, time required for one shot may be referred to as “molding cycle time” or “cycle time.”

One molding cycle has, for example, the metering process, the mold closing process, the pressurizing process, the mold clamping process, the filling process, the dwelling process, the cooling process, the depressurizing process, the mold opening process, and the ejection process in this order. The order here is order in which the processes are started. The filling process, the dwelling process, and the cooling process are executed during the mold clamping process. The start of the mold clamping process may coincide with the start of the filling process. The completion of the depressurizing process coincides with the start of the mold opening process.

Multiple processes may be simultaneously executed to reduce the molding cycle time. For example, the metering process may be executed during the cooling process of the previous molding cycle or may be executed during the mold clamping process. In such a case, the mold closing process may be executed at the beginning of the molding cycle. Furthermore, the filling process may be started during the mold closing process. Furthermore, the ejection process may be started during the mold opening process. When an on-off valve that opens and closes the flow channel of the nozzle 320 is provided, the mold opening process may be started during the metering process. This is because even when the mold opening process is started during the metering process, no molding material leaks from the nozzle 320 as long as the on-off valve closes the flow channel of the nozzle 320.

One molding cycle may include one or more processes other than the metering process, the mold closing process, the pressurizing process, the mold clamping process, the filling process, the dwelling process, the cooling process, the depressurizing process, the mold opening process, and the ejection process.

For example, before the start of the metering process after the completion of the dwelling process, a pre-metering suck back process to move the screw 330 backward to a preset metering start position may be executed. This makes it possible to reduce the pressure of the molding material accumulated in front of the screw 330 before the start of the metering process and to prevent a sudden backward movement of the screw 330 at the start of the metering process.

Furthermore, before the start of the filling process after the completion of the metering process, a post-metering suck back process to move the screw 330 backward to a preset filling start position (also referred to as “injection start position”) may be executed. This makes it possible to reduce the pressure of the molding material accumulated in front of the screw 330 before the start of the filling process and to prevent the leakage of the molding material from the nozzle 320 before the start of the filling process.

The controller 700 is connected to an operation device 750 that receives an input operation from a user and a display device 760 that displays a screen. The operation device 750 and the display device 760 may be composed of, for example, a touchscreen 770 as a one-piece structure. The touchscreen 770 serving as the display device 760 displays a screen under the control of the controller 700. For example, information such as the settings of the injection molding machine 10 and the current condition of the injection molding machine 10 may be displayed on the screen of the touchscreen 770. For example, operation parts such as buttons and input fields for receiving a user's input operation may be displayed on the screen of the touchscreen 770. The touchscreen 770 serving as the operation device 750 detects a user's input operation on the screen and outputs a signal according to the input operation to the controller 700. This enables the user to, for example, enter the settings (including setting values) for the injection molding machine 10 by operating the operation parts provided on the screen while checking information displayed on the screen. Furthermore, by operating the operation parts provided on the screen, the user can cause the injection molding machine 10 to perform operations corresponding to the operation parts. The operations of the injection molding machine 10 may be, for example, the operations (including stopping) of the mold clamping part 100, the ejector 200, the injection part 300, the movement part 400, and the like. Furthermore, the operations of the injection molding machine 10 may be, for example, the switching of the screen displayed on the touchscreen 770 serving as the display device 760.

The operation device 750 and the display device 760 of this embodiment, which are described as being integrated into the touchscreen 770, may be separately provided. Furthermore, two or more operation devices 750 may be provided. The operation device 750 and the display device 760 are disposed on the operation side (the negative side in the Y-axis direction) of the mold clamping part 100 (more specifically, the stationary platen 110).

### (Details of Controller)

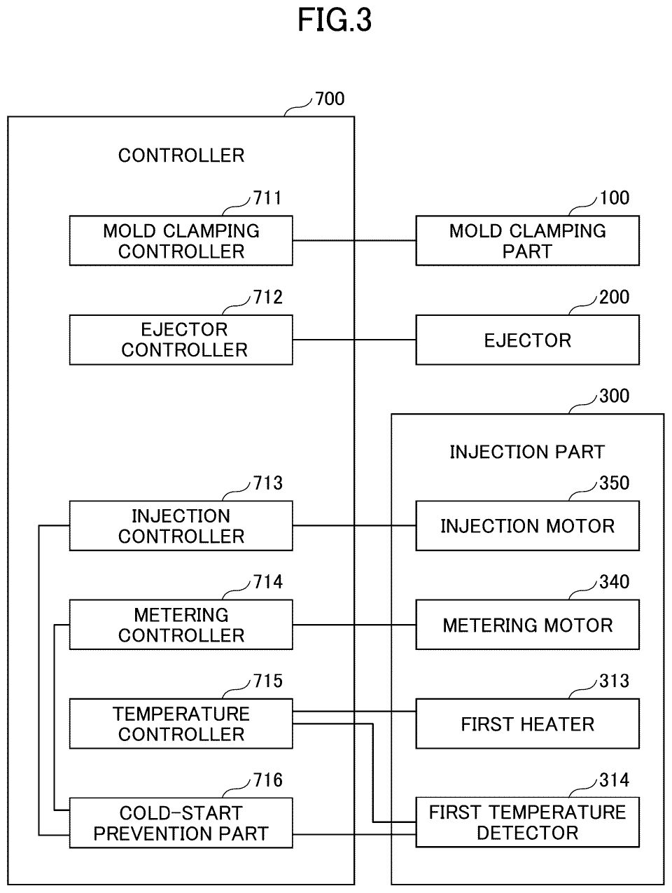

Next, an example of the components of the controller 700 will be described with reference to FIG. 3. The functional blocks illustrated in FIG. 3 are conceptual and do not have to be physically configured as illustrated. All or some of the functional blocks may be functionally or physically distributed or integrated in desired parts. Processing functions executed in the functional blocks are entirely or partly as desired executed by one or more programs executed in a CPU. Alternatively, the functional blocks may be realized as hardware by wired logic.

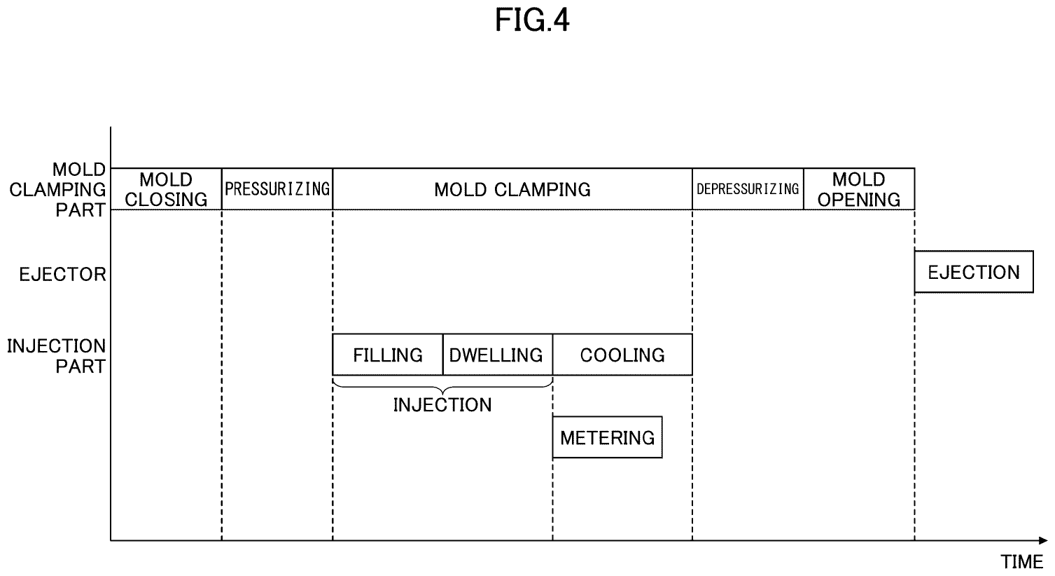

As illustrated in FIG. 3, the controller 700 includes, for example, a mold clamping controller 711, an ejector controller 712, an injection controller 713, a metering controller 714, a temperature adjuster 715, and a cold-start prevention part 716. The mold clamping controller 711 is configured to control the mold clamping part 100, and perform the mold closing process, the pressurizing process, the mold clamping process, the depressurizing process, and the mold opening process illustrated in FIG. 4. The ejector controller 712 is configured to control the ejector 200, and performs the ejection process.

The injection controller 713 is configured to control an injection drive source of the injection part 300, and performs the injection process. The injection motor 350 is used as an example of the injection drive source in the present embodiment, but the injection drive source may be a hydraulic cylinder or the like. As illustrated in FIG. 4, the injection process is performed during the mold clamping process. The injection controller 713 is configured to control an operation of an injecting member. The injecting member is disposed inside the cylinder 310, and injects a molding material from the cylinder 310 into the mold part 800. A screw 330 is used as an example of the injecting member in the present embodiment, but the injecting member may be a plunger.

The injection controller 713 monitors an actual value of a travel speed of the screw 330. The travel speed of the screw 330 is detected using a speed detector. The speed detector is, for example, an injection motor encoder 351. The injection controller 713 monitors an actual value of a pressure applied from the screw 330 to the molding material. The pressure can be detected using a pressure detector, such as the load detector 360 or the like. The pressure detector may be a nozzle pressure sensor or a cavity pressure sensor. As illustrated in FIG. 4, the injection process includes the filling process and the dwelling process in this order.

In the filling process, the screw 330 is moved forward, thereby feeding the molding material in liquid form, which is accumulated in front of the screw 330, to fill an inside of the mold part 800 with the molding material. In the filling process, for example, the injection motor 350 is controlled so that an actual value of the travel speed of the screw 330 inside the cylinder 310 becomes a set value. As the screw 330 travels forward in the filling process, an actual value of the pressure applied from the screw 330 to the molding material increases.

In the dwelling process, the screw 330 is pushed forward to feed a molding material to compensate an amount of the molding material decreased due to thermal contraction when cooled within the mold part 800. In the dwelling process, for example, the injection motor 350 is controlled so that an actual value of pressure applied from the screw 330 to the molding material becomes a set value.

The metering controller 714 controls a metering drive source of the injection part 300 to perform a metering process. The metering motor 340 is used as the metering drive source in the present embodiment, but the metering drive source may be a hydraulic pump or the like. The metering process can be performed during a cooling process to shorten a molding cycle time, as illustrated in FIG. 4. The cooling process starts after completion of the dwelling process. In the cooling process, the molding material in the cavity space 801 is solidified.

The temperature adjuster 715 is configured to adjust a temperature of the cylinder 310. The cylinder 310 is divided into multiple zones in the axial direction (e.g., the X-axis direction) of the cylinder 310. Each zone is provided with the first heater 313 and the first temperature detector 314. The first heater 313 heats the cylinder 310. The first temperature detector 314 detects an actual temperature of the cylinder 310. A set temperature is assigned to each zone.

The temperature adjuster 715 detects an actual temperature of each of the zones using the first temperature detector 314, and feedback-controls output of the first heater 313 per zone so that the actual temperature detected by the first temperature detector 314 becomes a set temperature. The multiple first heaters 313 may have identical configurations or different configurations. The first heater 313 is, for example, a band heater. Output of the first heater 313 is represented, for example, by a percentage (%) of energizing time per unit time. The larger the percentage (%) of the energizing time is, the greater the output of the first heater 313 is.

In a case where multiple first heaters 313, which are not illustrated, are provided in one zone, the multiple first heaters 313 are controlled so that the multiple first heaters 313 have the same percentage of energizing time. Moreover, multiple first temperature detectors 314, which are not illustrated, may be provided in one zone. The number of zones, the number of the first heaters 313, and the number of the first temperature detectors 314 may not be matched with one another.

A set temperature of the cylinder 310 is assigned to each of operation modes of the injection molding machine 10. The operation modes of the injection molding machine 10 include, for example, a molding mode and a temperature-retention mode. In the molding mode, a molding material is injected from the cylinder 310 into the mold part 800. In the temperature-retention mode, an operation of the screw 330 is stopped during the night, holidays, or the like. In the temperature-retention mode, a temperature of the cylinder 310 is set lower than a temperature of the cylinder 310 in the molding mode to inhibit carbonization of a molding material.

The operation modes of the injection molding machine 10 may further include a purge mode. In the purge mode, a molding material is injected from the cylinder 310 into the mold part 800, for example, after the temperature-retention mode and before the molding mode, thereby replacing the molding material inside the cylinder 310. In the purge mode, a temperature of the cylinder 310 is set lower than a temperature of the cylinder 310 in the molding mode.

The temperature adjuster 715 may cause the cylinder 310 to be heated. Heating of the cylinder 310 is performed, for example, when a set temperature for the molding mode is changed by raising a temperature during the molding mode, when the operation mode of the injection molding machine 10 is switched from the temperature-retention mode or the purge mode to the molding mode, or when an operation is restarted after interruption in electricity supply to a heater due to power cut or operational errors.

If a temperature range for heating the cylinder 310 is large, there may be a time lag between completion of heating of the cylinder 310 and completion of heating of the molding material inside the cylinder 310. If the metering motor 340 or the injection motor 350 causes the screw 330 to operate before the molding material inside the cylinder 310 is sufficiently heated, an excessive load is applied to the screw 330, which may damage the screw 330. Moreover, molding failure may occur.

Therefore, the cold-start prevention part 716 performs control of restricting an operation of the screw 330 until the molding material inside the cylinder 310 is sufficiently heated. This control of restricting an operation of the screw 330 is referred to as cold-start prevention. Moreover, a duration of the cold-start prevention is referred to as a cold-start prevention time.

An initial value to of the cold-start prevention time t is set based on a configuration of the injection part 300, a composition of a molding material, and the like. The initial value to is stored in a storage medium 702 in advance. The initial value to is not particularly limited. The initial value to is, for example, 15 minutes. The initial value to may be input by a user, or may be automatically set by the controller 700 upon acquiring information regarding a composition of a molding material.

A start point of the cold-start prevention time t is not limited to a point of completion of heating of the cylinder 310, namely, when an actual temperature of the cylinder 310 reaches a set temperature. The start point of the cold-start prevention time t can be appropriately set. For example, the start point of the cold-start prevention time t may be a point when an actual temperature of the cylinder 310 reaches a temperature that is shifted to a lower temperature side from the set temperature by a predetermined value.

If a temperature range for heating the cylinder 310 is small, the molding material inside the cylinder 310 has been already sufficiently heated. In this case, if the initial value to is used as the cold-start prevention time, a standing time until production of molded products is restarted becomes unnecessarily long.

The cold-start prevention part 716 will be described in detail below. When a first condition is met, the initial value to is used as the cold-start prevention time t, and control of restricting an operation of the screw 330 for a duration of the initial value to is performed. When the first condition is met, the cold-start prevention part 716 determines whether or not a second condition, which is different from the first condition, is met to determine whether or not a value shorter than the initial value to will be used as the cold-start prevention time t. Since the second condition is considered in addition to the first condition, the cold-start prevention time t can be adjusted simply and appropriately.

When the second condition is met, as well as satisfying the first condition, the cold-start prevention part 716 uses a value shorter than the initial value to as the cold-start prevention time, or reports that a value shorter than the initial value to will be used as the cold-start prevention time. The reporting includes displaying on a screen or outputting a sound. Once a predetermined operation performed by a user is detected after reporting, the cold-start prevention part 716 uses a value shorter than the initial value to as the cold-start prevention time. Using the value shorter than the initial value to as the cold-start prevention time t includes setting the cold-start prevention time t at zero, namely, not performing cold-start prevention.

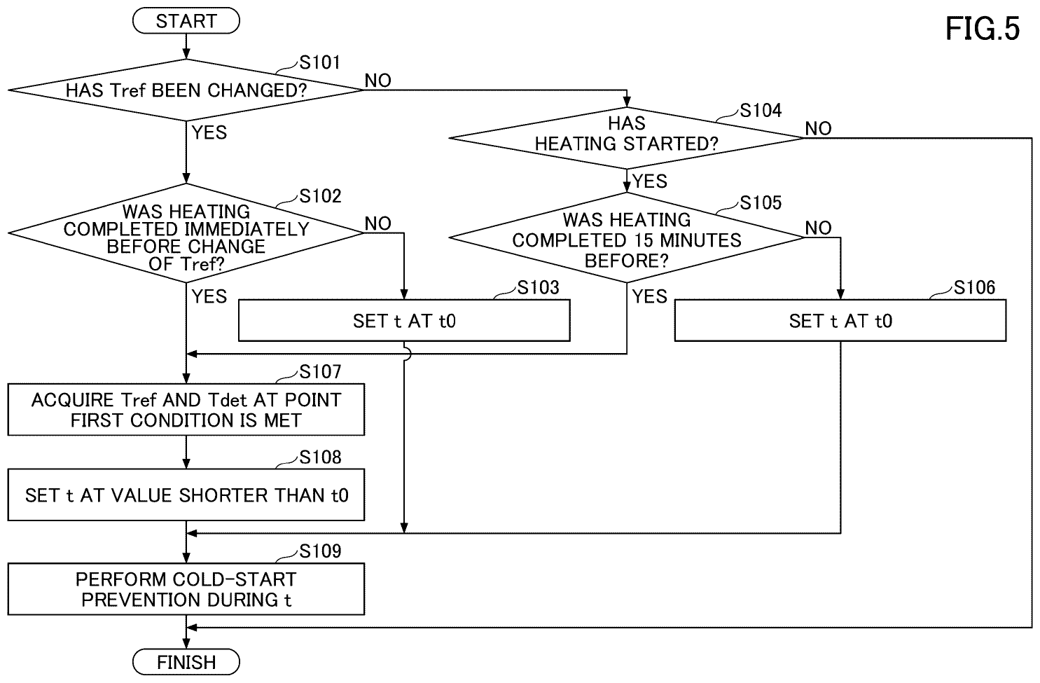

Next, one example of a process carried out by the cold-start prevention part 716 will be described with reference to FIG. 5. A step S101 and subsequent steps thereof illustrated in FIG. 5 are repeated per predetermined period, for example, during the operations of the injection molding machine 10. First, the cold-start prevention part 716 determines whether or not the set temperature Tref of the cylinder 310 has been changed (Step S101). A target zone for judging can be the very front zone of the cylinder 310 (the closest zone to the nozzle 320).

The molding material is injected from the inside of the cylinder 310 into the mold part 800 via the nozzle 320. If the metering motor 340 or the injection motor 350 causes the screw 330 to operate in a state in which the molding material is not sufficiently melted in the very front zone of the cylinder 310, an excessive load is applied to the screw 330, which may damage the screw 330. Moreover, molding failure may occur.

During the process performed by the cold-start prevention part 716, the set temperature Tref of the cylinder 310 can be the set temperature Tref of the very front zone of the cylinder 310. In the process performed by the cold-start prevention part 716, the actual temperature Tdet of the cylinder 310 can be an actual temperature Tdet of the very front zone of the cylinder 310.

When the set temperature Tref of the cylinder 310 is changed (step S101, YES), the cold-start prevention part 716 determines whether or not heating of the cylinder 310 has been completed immediately before the change of the set temperature Tref (step S102). The state where the heating of the cylinder 310 has been completed is a state where the actual temperature Tdet of the cylinder 310 reaches the set temperature Tref.

At the steps S101 and S102, the first condition is a state in which the set temperature Tref of the cylinder 310 has been changed. A second condition is a state in which heating of the cylinder 310 has been completed immediately before the first condition is met. Examples of a case where the first condition is met, then the second condition is met include a case where the set temperature Tref for the molding mode has been changed during the molding mode.

The set temperature Tref to be changed is not limited to the set temperature Tref for the molding mode, and it may be a set temperature Tref for a purge mode. Specifically, a case where the first condition is met and the second condition is met may be a case where the set temperature Tref for the purge mode is changed during the purge mode. In the temperature-retention mode, an operation of the screw 330 is stopped, thus the temperature-retention mode is not a target of the cold-start prevention.

When the first condition is met but the second condition is not met at the steps S101 and S102 (step S102, NO), heating of the cylinder 310 has not been completed before the first condition is met. Therefore, the molding material in the cylinder 310 is not sufficiently heated. In this case, the cold-start prevention part 716 sets the cold-start prevention time t at the initial value to (step S103), followed by proceeding to a step S109 and subsequent steps thereof. The step S109 and subsequent steps thereof will be described below.

When the first condition is met and the second condition is met at the steps S101 and S102 (step S102, YES), if a difference ΔT (ΔT=Tref−Tdet) between the set temperature Tref of the cylinder 310 and the actual temperature Tdet of the cylinder 310 is small at a point when the first condition is met, the melting material in the cylinder 310 is sufficiently heated. In this case, the cold-start prevention part 716 proceeds to a step S107 and its subsequent steps. The step S107 and subsequent steps thereof will be described below.

When the set temperature Tref of the cylinder 310 has not been changed (step S101, NO), the cold-start prevention part 716 determines whether or not heating of the cylinder 310 has started (step S104). Examples of a state in which the heating of the cylinder 310 has started include a state in which the operation mode of the injection molding machine 10 is changed from the temperature-retention mode or the purge mode to the molding mode, and a state in which an operation is restarted after interruption in electricity supply due to power cut or operational errors.

As the operation modes of the injection molding machine 10, the molding mode and the temperature-retention mode are provided. In the molding mode, a set temperature Tref for a molding cycle is used. In the temperature-retention mode, a set temperature Tref for temperature retention is used. A purge mode may be provided as an operation mode of the injection molding machine 10. In the purge mode, a set temperature Tref for purging is used.

When heating of the cylinder 310 has not been started (step S104, NO), the set temperature Tref of the cylinder 310 has not been changed and the operation of the injection molding machine 10 has not been interrupted, thus the molding material in the cylinder 310 has been already sufficiently heated. In this case, the cold-start prevention part 716 ends the process without performing the step S109.

When heating of the cylinder 310 has been started (step S104, YES), the cold-start prevention part 716 determines whether or not heating of the cylinder 310 was completed a set time prior to (e.g., 15 minutes before) the start of the heating of the cylinder 310 (step S105). In FIG. 5, the set time is 15 minutes that is identical to the initial value to, but the set time can be set as appropriate.

At the steps S104 and S105, a state in which heating of the cylinder 310 has started is the first condition. A state in which the heating of the cylinder 310 is completed a set time prior to a point when the first condition is met is the second condition. Examples of a case where the first condition is met, then the second condition is met include a case that a period of power cut is short and operation is immediately restarted, and a case that an operation is immediately restarted after an operational error caused by a user.

When the first condition is met but the second condition is not met at the steps S104 and $105 (step S105, NO), heating of the cylinder 310 has not been completed before the first condition is met. Therefore, a molding material in the cylinder 310 is not sufficiently heated. In this case, the cold-start prevention part 716 sets the cold-start prevention time t at the initial value to (step S106), followed by proceeding to the step S109 and subsequent steps thereof. The step S109 and subsequent steps thereof will be described below.

When the first condition is met and the second condition is met at the steps S104 and S105 (step S105, YES), if a difference ΔT (ΔT=Tref−Tdet) between the set temperature Tref of the cylinder 310 and the actual temperature Tdet of the cylinder 310 is small at a point when the first condition is met, the molding material in the cylinder 310 has been already sufficiently heated. In this case, the cold-start prevention part 716 proceeds to the step S107 and subsequent steps thereof. The step S107 and subsequent steps thereof will be described later.

At the step S107, the cold-start prevention part 716 acquires the set temperature Tref and actual temperature Tdet of the cylinder 310 at the point when the first condition is met. Tref and Tdet associated with time are stored in a storage medium 702. The stored data is read upon use.

Next, the cold-start prevention part 716 determines whether or not a value shorter than the initial value to will be used as the cold-start prevention time t based on the set temperature Tref and actual temperature Tdet of the cylinder 310 at the point when the first condition is met. The cold-start prevention part 716 sets a value shorter than the initial value to as the cold-start prevention time t based on ΔT (ΔT=Tref−Tdet) at the point when the first condition is met (step S108). The smaller ΔT at the point when the first condition is met is, the smaller the shortage of heat of the heated molding material in the cylinder 310 is. Therefore, the cold-start prevention time t may be set shorter, as ΔT at the point when the first condition is met is smaller. The cold-start prevention time t may be set in a stepwise manner according to ΔT. Moreover, the cold-start prevention time t may be set at zero. When ΔT at the point when the first condition is met is too large, the molding material in the cylinder 310 is not sufficiently heated, thus the cold-start prevention time t may be set at the initial value to.

According to the present embodiment, the cold-start prevention part 716 sets a value shorter than the initial value to as the cold-start prevention time t based on ΔT at the point when the first condition is met. However, a value shorter than the initial value to may be set as the cold-start prevention time t based on a parameter other than ΔT. For example, a ratio between Tref and Tdet may be used instead of ΔT.

When the first condition is a state in which the set temperature Tref of the cylinder 310 is changed, or a state in which heating of the cylinder 310 has started, the second condition may be a state in which the heating of the cylinder 310 is completed before a set time (e.g., 15 minutes) is passed since the point when the first condition is met. When the second condition is met, it is also considered that the molding material in the cylinder 310 has been already sufficiently heated. The cold-start prevention part 716 may determine whether or not a value shorter than the initial value to will be used as the cold-start prevention time based on the time lag between the point when the first condition is met and the completion of the heating of the cylinder 310.

At the step S109, the cold-start prevention part 716 performs the cold-start prevention for a duration of t, which is set in advance. Then, the cold-start prevention part 716 finishes the process.

In the present embodiment, the actual temperature of the cylinder 310 is used as a starting point of the cold-start prevention time t. However, an actual temperature of the mold part 800 may be also used as the starting point. The mold part 800 may include a hot runner system. The hot runner system includes a heater configured to heat a flow channel for a molding material, and a temperature detector configured to detect an actual temperature of the flow channel for a molding material.

The temperature adjuster 715 controls the heater so that the actual temperature of the flow channel for a molding material becomes a set temperature.

The temperature adjuster 715 may heat the mold part 800 before a molding cycle is started again. There is a time lag between detection of completion of heating of the mold part 800 by the temperature detector of the mold part 800 and completion of heating of the entire flow channel for a molding material. If the metering motor 340 or the injection motor 350 causes the screw 330 to operate in a state where the mold part 800 is not sufficiently heated, the mold part 800 may be damaged or molding failure may occur. Therefore, the cold-start prevention part 716 may control to restrict an operation of the screw 330 until the mold part 800 is sufficiently heated.

Although the embodiments of the controller for the injection molding machine, the injection molding machine, and the control method for the injection molding machine according to the present disclosure have been described above, the present disclosure is not limited to the above-described embodiments and the like. Various changes, modifications, substitutions, additions, deletions, and combinations are possible within the scope of claims recited. These naturally fall within the technical scope of the present disclosure.

What is claimed is:

1. A controller for an injection molding machine including an injecting member configured to inject a molding material from a cylinder into a mold part, and a drive source configured to cause the injecting member to operate, the controller comprising:
a cold-start prevention part configured to, when a first condition is met, restrict an operation of the injecting member during a cold-start prevention time that is set in advance,
when the first condition is met, the cold-start prevention part determining whether or not a second condition, which is different from the first condition, is met to determine whether or not a value shorter than an initial value will be used as the cold-start prevention time.

2. The controller according to claim 1, wherein
when the first condition is met and the second condition is met, the cold-start prevention part uses a value shorter than the initial value as the cold-start prevention time, or reports that a value shorter than the initial value will be used as the cold-start prevention time.

3. The controller according to claim 1, wherein
the first condition includes a state in which a set temperature of the cylinder or the mold part is changed, and
the second condition includes a state in which heating of the cylinder or the mold part is completed immediately before the first condition is met, or a state in which heating of the cylinder or the mold part is completed before a set time is passed since the first condition is met.

4. The controller according to claim 1, wherein
the first condition includes a state in which heating of the cylinder or the mold part has started, and
the second condition includes a state in which heating of the cylinder or the mold part is completed a set time prior to a point when the first condition is met, or heating of the cylinder or the mold part is completed before a set period is passed since the first condition is met.

5. The controller according to claim 1, wherein
the cold-start prevention part determines whether or not a value shorter than the initial value will be used as the cold-start prevention time based on a set temperature and actual temperature of the cylinder or the mold part at a point when the first condition is met.

6. The controller according to claim 1, wherein
the cold-start prevention part determines whether or not a value shorter than the initial value will be used as the cold-start prevention time based on a time lag between a point when the first condition is met and completion of heating of the cylinder or the mold part.

7. An injection molding machine comprising:
the controller according to claim 1;
the injecting member; and
the drive source.

8. A control method for an injection molding machine including an injecting member configured to inject a molding material from a cylinder into a mold part, and a drive source configured to cause the injecting member to operate, the control method comprising:
when a first condition is met, performing control of restricting an operation of the injecting member during a cold-start prevention time that is set in advance; and
when the first condition is met, determining whether or not a second condition, which is different from the first condition, is met to determine whether or not a value shorter than an initial value will be used as the cold-start prevention time.

9. The controller according to claim 2, wherein
the first condition includes a state in which a set temperature of the cylinder or the mold part is changed, and
the second condition includes a state in which heating of the cylinder or the mold part is completed immediately before the first condition is met, or a state in which heating of the cylinder or the mold part is completed before a set time is passed since the first condition is met.

10. The controller according to claim 2, wherein
the first condition includes a state in which heating of the cylinder or the mold part has started, and
the second condition includes a state in which heating of the cylinder or the mold part is completed a set time prior to a point when the first condition is met, or heating of the cylinder or the mold part is completed before a set period is passed since the first condition is met.

11. The controller according to claim 2, wherein
the cold-start prevention part determines whether or not a value shorter than the initial value will be used as the cold-start prevention time based on a set temperature and actual temperature of the cylinder or the mold part at a point when the first condition is met.

12. The controller according to claim 2, wherein
the cold-start prevention part determines whether or not a value shorter than the initial value will be used as the cold-start prevention time based on a time lag between a point when the first condition is met and completion of heating of the cylinder or the mold part.

13. The injection molding machine according to claim 7, wherein
when the first condition is met and the second condition is met, the cold-start prevention part of the controller uses a value shorter than the initial value as the cold-start prevention time, or reports that a value shorter than the initial value will be used as the cold-start prevention time.
